(19) United States
(12) Patent Application Publication
(10) Pub. No.: US 2016/0335722 A1
(43) Pub. Date: Nov. 17, 2016

(54) SYSTEM AND METHOD FOR ASSIGNING CUSTOMER OWNERSHIP BASED ON PROFITABILITY

(71) Applicant: Joseph BOUS, Washington, DC (US)

(72) Inventor: Joseph BOUS, Washington, DC (US)

(21) Appl. No.: 14/713,504

(22) Filed: May 15, 2015

(51) Int. Cl. G06Q 40/06

(52) U.S. Cl. CPC G06Q 40/06

(57) ABSTRACT

Disclosed are systems, methods, and non-transitory computer-readable storage media for conducting sales. A system configured to practice the method can calculate a profitability factor for a transaction between a business and a customer, retrieve a value factor representing a value of the business, retrieve a list of outstanding ownership interests in the business, and assign, in association with the transaction, an ownership interest in the business, wherein the ownership interest is based on at least one of the profitability factor, the value factor, and the list of outstanding ownership interests in the business. The ownership interest can be stock in the business, an option to purchase stock in the business, or a derivative, for example. The system can further determine a timetable, and assign portions of the ownership interest at multiple time intervals based on the timetable, so the entire ownership interest is assigned at the end of the timetable.

### BACKGROUND

1. Technical Field

The present disclosure relates to business-customer relations, and more particularly to assigning ownership in a business based on some aspect of the business relationship with a customer.

2. Introduction

The Securities Exchange Commission has long established rules and regulations restricting investment. For example, a company had to ‘go public’ in order to offer investment or ownership opportunities to members of the public. This process offers many opportunities, but imposes many associated limitations. Companies that choose to remain privately held or closely held are limited to soliciting investments from individuals or businesses meeting certain criteria. Recent legislation, such as the JOBS Act, has loosened the regulations of ownership and investment in non-public companies, thereby creating new opportunities and an entirely unfamiliar business climate.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example interaction between a customer and a business with an assignment of ownership based on profitability;

FIG. 2 illustrates an example ownership amount formula;

FIG. 3 illustrates an example block diagram of an example interaction between a customer and a business;

FIG. 4 illustrates an example transaction thumbnail table;

FIG. 5 illustrates a first example method embodiment for assigning customer ownership based on a profitability factor;

FIG. 6 illustrates a second example method embodiment for calculating an ownership interest based on transaction variables; and

FIG. 7 illustrates a basic system or computing device embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

The recent relaxation of rules and regulations in business investment and ownership can allow for more flexible relationships between customers and businesses. The approaches disclosed herein allow for a business to reward or incentivize customer loyalty or profitability by granting customers an ownership interest in the business. While this approach is not restricted to any single business type and can apply to virtually any business, the examples set forth herein will primarily discuss a business of a mortgage lender with a customer who is borrowing from the mortgage lender. The customer (or borrower) borrowing from the mortgage lender generates a certain amount of profit or other benefit for the lender. The lender can reward the borrower based on that profit by assigning an ownership interest in the lender (or a related or associated company) back to the borrower. For example, the lender can grant the borrower a number of shares, stock, or options to purchase stock in the lender, the amount of which is based on the actual or expected profitability or other aspect of the customer-lender relationship. The amount of the ownership interest assigned can also vary based on other factors relating to one or more of the lender, the company, or the transaction. Some example factors include a number of outstanding shares, a valuation of the business, projected profitability, profit margin, discounts, existing ownership of the lender in the business, and so forth.

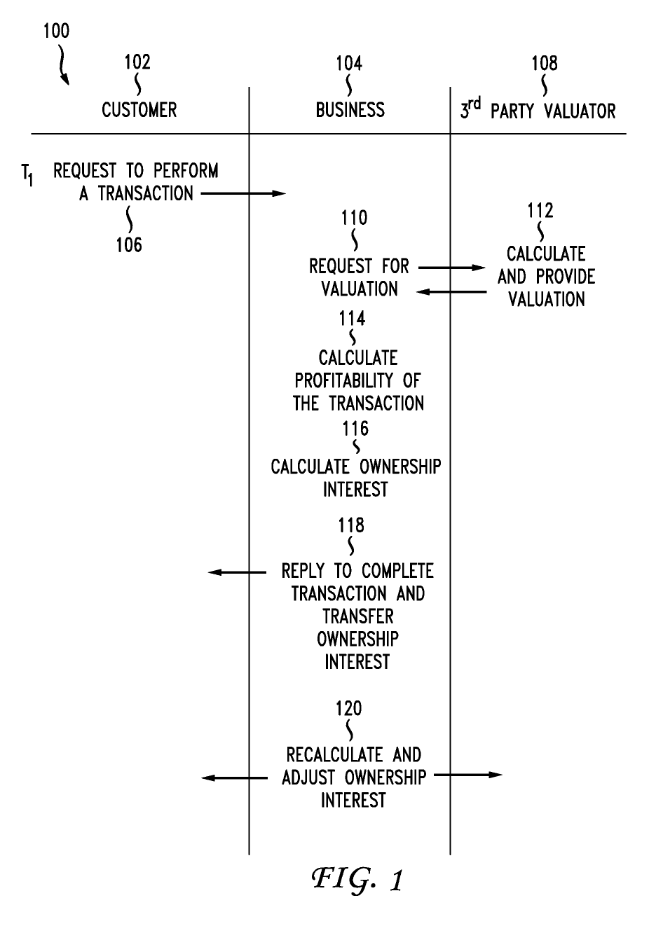

FIG. 1 illustrates an example interaction 100 between a customer 102 and a business 104 with an assignment of ownership based on profitability of a business transaction or relationship between the customer 102 and the business 104. The customer 102 contacts the business 104 with a request to perform a transaction 106, such as applying for a mortgage. The business 104 can request a valuation 110 of the business, such as from a 3^{rd} party valuator 108. The 3^{rd} party valuator 108 calculates and provides the valuation 112 back to the business 104. The business 104 can make this request 110 prior to the customer request 106 or in response to the customer request 106. Further, the 3^{rd} party valuator 108 can provide the valuation in ways that do not involve immediate calculation, such as performing a database lookup of the business value.

Based on details of the transaction, the business 104 can calculate a profitability of the transaction 114. Then, using the profitability of the transaction and the valuation of the business, the business 104 can calculate an ownership interest 116 to provide in exchange for in conjunction with the transaction. The business 104 can then reply to the request in order to complete or initiate the transaction and transfer of the ownership interest 118.

The business 104 can also determine an amount and type of the ownership interest, or can generate several different options for the ownership interest, from which the business 104 or customer 102 can select. For example, the business 104 can determine that the projected profitability for the transaction is $5,000 and can offer the customer 102 $5,000 worth of stock in the business at the current valuation, or can offer the customer 102 a $6,000 package of stock options at $1,000 for a discount equivalent to $5,000. In other variations, the business 104 can formulate a schedule for parceling out $5,000 in stock in multiple transfers over the life of a mortgage, for example. In this case, the business 104 can recalculate the profitability of the transaction, the valuation of the business, and/or any other details relating to the transaction or its ongoing attributes.

In the example of FIG. 1 and throughout, when the business is characterized as performing an action, the business can be a human agent acting on behalf of the business or can be one or more computer system configured to perform all or part of that action, such as a computer server conducting business transactions and communications.

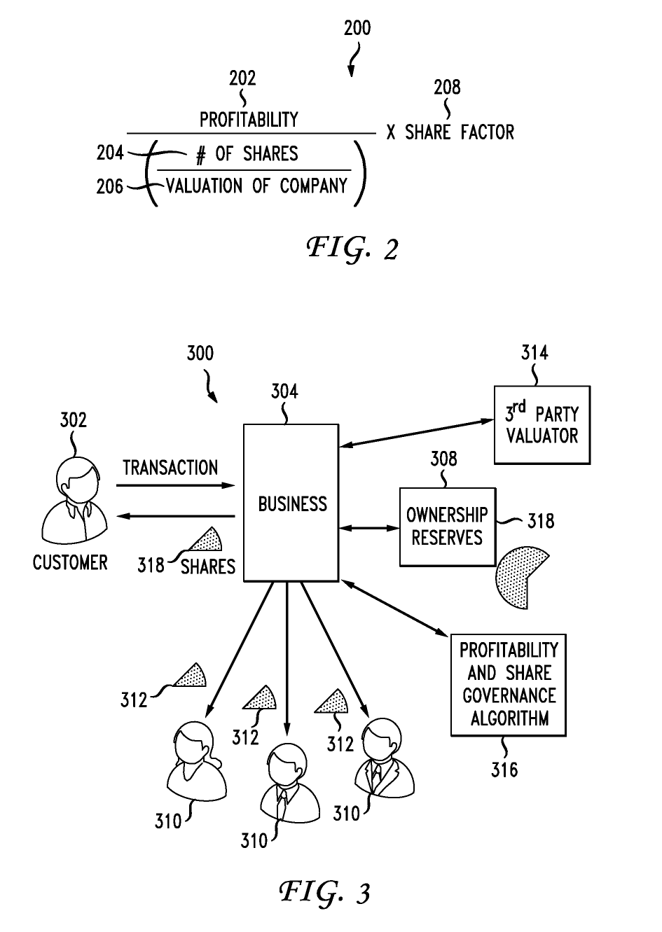

FIG. 2 illustrates an example ownership amount formula 200. This formula 200 illustrates some variables and some possible relationships for determining an amount of ownership interest to provide in association with a transaction. The formula can include other variables and can arrange those variables in different arrangements, and with different constants. This example formula 200 shows that profitability 202 of a transaction can be divided by the number of shares 204 over the valuation of the company 206 and multiplied by a share factor 208 to calculate an amount of ownership to grant along with the transaction. The formula can include different configurations and/or different variables for different types of transactions or for different business goals. For example, the formula can include a multiplier reflecting customer loyalty, which would increase the amount of the ownership interest to grant as customer loyalty increases.

FIG. 3 illustrates an example block diagram 300 of an example interaction for completing a transaction between a customer 302 and a business 304. The customer 302 turns to the business 304 to initiate a transaction. The business retrieves some kind of valuation of the business from a 3^{rd} party valuator 314. The valuation of the business can reflect a total value of the business, and can be based on actual, estimated, and/or projected numbers for the business. The business 304 examines details relating to the transaction and processes the valuation and transaction details with a profitability and share governance algorithm 316. The algorithm can consider, for example, outstanding shares 312 granted to previous customers 310 as well as ownership reserves 308. In this case, the outstanding shares 312 plus the ownership reserves 318 are the total of outstanding shares, but there can be other outstanding ownership shares, such as shares awarded to executives in the business, initial investors, and so forth.

The business 304 uses the output from the algorithm 316 to determine how many shares 318 in the business 304 to award the customer 302 in connection with the transaction. The business 304 can award the shares 318 in the business to the customer 302, to an account held in behalf of the customer 302, to a beneficiary designated by the customer 302, to a retirement account, to some other entity, or to some combination thereof. In one embodiment, the business 304 awards some portion of the shares 318 upon starting the transaction, such as when the customer 302 signs a mortgage agreement. Then the business 304 holds in trust a remaining portion of the share 318 to parcel out as the customer 302 proceeds to pay the mortgage over the mortgage period. In this case, the algorithm 316 can factor in risk of default, for example, and adjust the share 318 to be awarded throughout the lifetime of the mortgage as that risk of default fluctuates. This approach can reflect the risk of the profitability of the transaction in the shares 318 awarded. The ownership reserves 308 can include multiple different pools of ownership interests in the business 304. For example, the ownership reserves 308 can include a pool of non-voting shares and a pool of voting shares. As a user

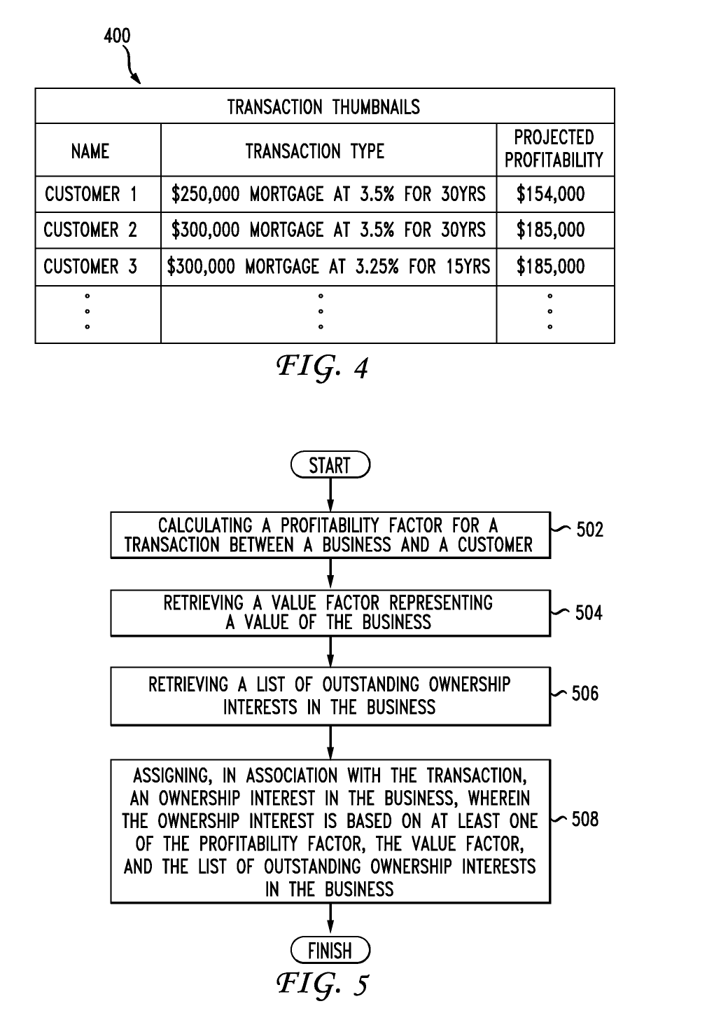

In some cases, the algorithm 316 does not calculate an actual profitability of the transaction, such as for the sake of consistency or for speed or ease in calculation. In this case, the algorithm 316 can simply refer to a table, such as the example transaction thumbnail table 400 shown in FIG. 4. The table 400 can include actual historical profitability for individual customers, as shown in this example. However, the table 400 can include calculated scenarios instead of or in addition to actual profitability. The algorithm 316 can check the table 400 for an entry that is sufficiently close to a given transaction, and use that entry if available. If the algorithm 316 does not find a sufficiently close entry to the given transaction, the algorithm 316 can calculate the profitability and include that transaction in the table 400 for future reference. Similarly, the table 400 can include categories or ranges of transaction details to simplify forecasting transaction profitability.

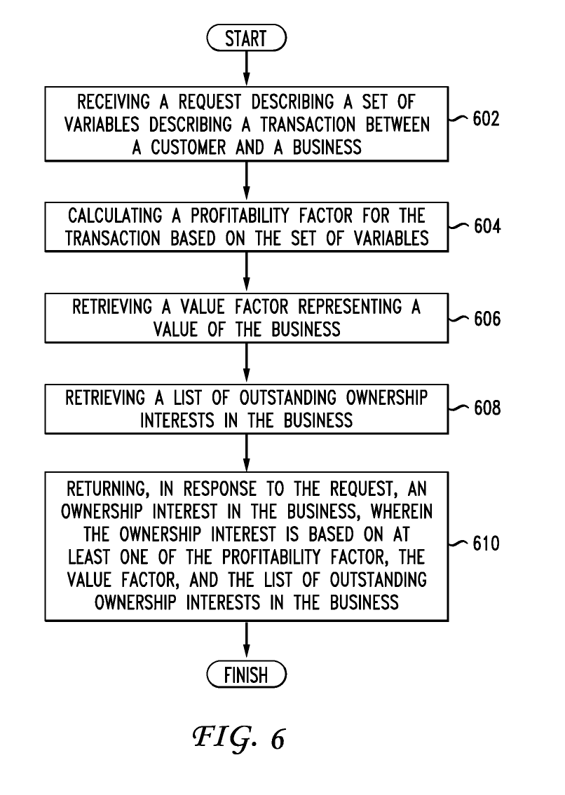

Having disclosed some basic system components, the disclosure now turns to the example method embodiments shown in FIGS. 5 and 6. The method embodiments are each discussed in terms of a system configured to perform the method. FIG. 5 illustrates a first example method embodiment for assigning customer ownership based on a profitability factor. The system can calculate a profitability factor for a transaction between a business and a customer (502). The system can calculate the profitability factor by calculating an actual profitability for the transaction, and revising the ownership interest in the business based on the actual profitability. The system can alternatively perform a lookup in a database or table of pre-calculated similar transactions. The profitability factor, and the resulting ownership interest, can further be based on current profitability metrics of the business. As the business becomes more or less efficient (and more or less profitable) in handling a particular type of transaction, the profitability factor may change accordingly. The profitability factor can reflect an expected amount of profit to the business from handling the transaction.

The system can retrieve a value factor representing a value of the business (504) and retrieve a list of outstanding ownership interests in the business (506). The list of outstanding ownership interests in the business can be a simple list of an amount of outstanding shares and/or shares promised to be assigned. The value factor can be provided by a third-party appraisal, and can reflect an actual value of the business as based on one or more factors such as assets, expected profitability, stock price, market health, cash flow, and so forth.

The system can assign, in association with the transaction, an ownership interest in the business, wherein the ownership interest is based on at least one of the profitability factor, the value factor, and the list of outstanding ownership interests in the business (508). The ownership interest can be stock in the business, an option to purchase stock in the business, a derivative, or other ownership transfer mechanism, or promise or obligation to assign an ownership interest at a later date. The ownership interest can be a non-voting share of the business or a voting share of the business.

The system can optionally determine a timetable for the transaction, and assign portions of the ownership interest at multiple time intervals based on the timetable, wherein all of the ownership interest is assigned when the timetable is completed. In this case, the system can, at each of the multiple time intervals, retrieve at least one of an updated profitability factor, an updated value factor, and an updated list of outstanding ownership interests, and recalculate a respective portion of the ownership interest based on the at least one of the updated profitability factor, the updated value factor, and the updated list of outstanding ownership interests. The ownership interest can vest over a period of time associated with the transaction. The system can assign the ownership interest by transferring the ownership interest to one of an individual, a business entity, a retirement account, a non-profit organization, or a trust, for example. The system can assign the ownership interest with at least one restriction, such as permanent or temporary restrictions on reselling the ownership interest or restrictions regarding to whom the ownership interest may be resold. The system can assign the ownership interest as directed by the customer, such as to a trust, to a retirement fund, to a spouse, a non-profit organization, and so forth.

The system can calculate the profitability factor, retrieve the value factor, retrieve the list of outstanding ownership interests, and/or assign the ownership interest after initiation of the transaction. For example, the system may pre-calculate a table of values for the profitability factor in advance of the transaction, or can calculate the actual profitability factor as the transaction proceeds. Similarly, the system may retrieve the list of outstanding ownership interests after initiating the transaction, or the system can have a list of outstanding ownership interests ready prior to the transaction.

The system can assign a status indicator to the customer, wherein the status indicator is associated with the transaction. The status indicator can then be used in social networks, in an online portal for account management, as part of customer correspondence or customer support, in entertainment media, in publications or advertising, and so forth. The business can use the status indicator as a basis to reward loyalty, profitability, or repeat transactions.

The system can assign, in association with the transaction, a second ownership interest in the business to an entity that referred the customer to the business. This can be considered a referral fee or a way to reward entities that funnel profitable customers to the business. The entity can be an organization, an individual, or an existing customer of the business.

While the examples described here are mortgages, the same principles can apply to other transactions, such as sales of a good or service, such as sales of soft drinks or gasoline. In the soft drink example, the soft drink company can calculate the profit for selling a 20 ounce bottle, and provide a corresponding share of the soft drink company to customers who purchase a 20 ounce bottle. In this example, the share would be miniscule, but could add up to reward loyal customers with an ownership interest in the soft drink company. Further, the soft drink company would have a way to identify the usage habits of a very profitable customer segment. In this example, customers wishing to receive the shares from the soft drink company could create an online profile or account. Then, the soft drink company has more information about the customers and can target advertisements, promotions, communications, or other bonuses to customers who are already shareholders. In another example, the soft drink company could invite a certain segment of those customers to participate in focus group or consumer feedback sessions. Such an online profile or account for shareholders could enable shareholders to post to social media, and invite others to participate as well. In this way, the ownership and profitability of the company can be distributed to customers based on the profits brought to the company by the customers.

FIG. 6 illustrates a second example method embodiment for calculating an ownership interest based on transaction variables, such as a service or API for calculating the ownership interest to assign for a transaction. In this embodiment, the system can receive a request describing a set of variables describing a transaction between a customer and a business (602). The system can calculate a profitability factor for the transaction based on the set of variables (604), and retrieve a value factor representing a value of the business (606). The system can retrieve a list of outstanding ownership interests in the business (608). The system can return, in response to the request, an ownership interest in the business, wherein the ownership interest is based on at least one of the profitability factor, the value factor, and the list of outstanding ownership interests in the business (610).

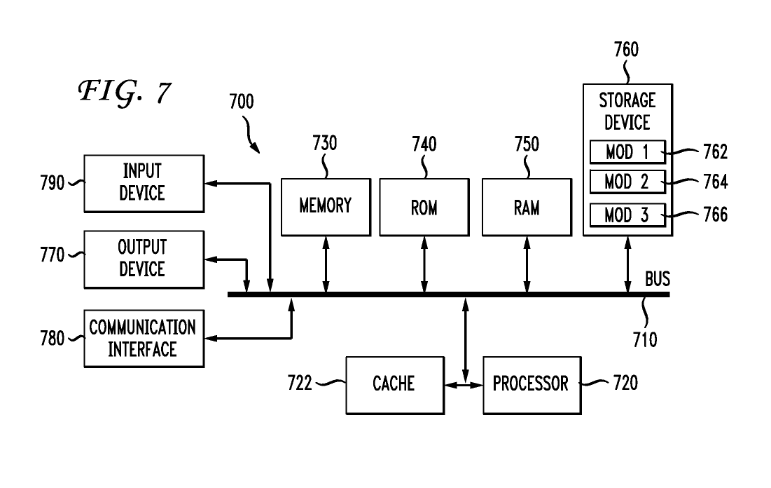

FIG. 7 illustrates an example system 700 having a general-purpose computing device 700, including a processing unit (CPU or processor) 720 and a system bus 710 that couples various system components including the system memory 730 such as read only memory (ROM) 740 and random access memory (RAM) 750 to the processor 720. These and other modules can be configured to control the processor 720 to perform various actions. Other system memory 730 can be available for use as well. It can be appreciated that the disclosure can operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 can essentially be a completely self-contained computing system, containing multiple cores or processors, a bus, memory controller, cache, etc. A multi-core processor can be symmetric or asymmetric.

The system bus 710 can be any of several types of bus structures including a memory bus or memory controller, a peripheral bus, and a local bus using any of a variety of bus architectures. A basic input/output (BIOS) stored in ROM 740 or the like, can provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer readable storage media provide nonvolatile storage of computer readable instructions, data structures, program modules and other data for the computing device 700. In one aspect, a hardware module that performs a particular function includes the software component stored in a tangible and/or intangible computer-readable medium in connection with the necessary hardware components, such as the processor 720, bus 710, display 770, and so forth, to carry out the function. The basic components are known to those of skill in the art and appropriate variations are contemplated depending on the type of device, such as whether the device 700 is a small, handheld computing device, a desktop computer, or a computer server.

Although the exemplary embodiment described herein employs the hard disk 760, it should be appreciated by those skilled in the art that other types of computer readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, can also be used in the exemplary operating environment. Tangible computer-readable storage media expressly exclude media such as energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. The input device 790 can be used by the presenter to indicate the beginning of a speech search query. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here can easily be substituted for improved hardware or firmware arrangements as they are developed.

For clarity of explanation, the illustrative system embodiment is presented as including individual functional blocks including functional blocks labeled as a “processor” or processor 720. The functions these blocks represent can be provided through the use of either shared or dedicated hardware, including, but not limited to, hardware capable of executing software and hardware, such as a processor 720, that is purpose-built to operate as an equivalent to software executing on a general purpose processor. For example the functions of one or more processors presented in FIG. 7 can be provided by a single shared processor or multiple processors. (Use of the term “processor” should not be construed to refer exclusively to hardware capable of executing software.) Illustrative embodiments can include microprocessor and/or digital signal processor (DSP) hardware, read-only memory (ROM) 740 for storing software performing the operations discussed below, and random access memory (RAM) 750 for storing results. Very large scale integration (VLSI) hardware embodiments and custom VLSI circuitry in combination with a general purpose DSP circuit can also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 7 can practice all or part of the recited methods, can be a part of the recited systems, and/or can operate according to instructions in the recited tangible computer-readable storage media. Generally speaking, such logical operations can be implemented as modules configured to control the processor 720 to perform particular functions according to the programming of the module. For example, FIG. 7 illustrates three modules Mod1 762, Mod2 764 and Mod3 766 which are modules configured to control the processor 720. These modules can be stored on the storage device 760 and loaded into RAM 750 or memory 730 at runtime or can be stored in other computer-readable memory locations.

Embodiments within the scope of the present disclosure can also include tangible computer-readable storage media for carrying or having computer-executable instructions or data structures stored thereon. Such computer-readable storage media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure can be practiced in network computing environments with many types of computer system configurations, including personal computers, hand-held devices, multi-processor systems, microprocessor-based or programmable consumer electronics, network PCs, minicomputers, mainframe computers, and the like. Embodiments can also be practiced in distributed computing environments where tasks are performed by local and remote processing devices that are linked (either by hardwired links, wireless links, or by a combination thereof) through a communications network. In a distributed computing environment, program modules can be in both local and remote memory storage devices.

Although the above description can contain specific details, they should not be construed as limiting the claims in any way. Other configurations of the described embodiments are part of the scope of this disclosure. For example, this semi-opaque method of conducting sales can apply to any time or date sensitive good or service, such as airline travel, opera tickets, hotel reservations, and so on. Accordingly, the appended claims and their legal equivalents should define the recited embodiments, rather than any specific examples given.

I claim:

1. A method comprising:
calculating a profitability factor for a transaction between a business and a customer;
retrieving a value factor representing a value of the business;
retrieving a list of outstanding ownership interests in the business; and
assigning, in association with the transaction, an ownership interest in the business, wherein the ownership interest is based on at least one of the profitability factor, the value factor, and the list of outstanding ownership interests in the business.

2. The method of claim 7, wherein the ownership interest comprises at least one of stock in the business, an option to purchase stock in the business, and a derivative.

3. The method of claim 7, further comprising:
determining a timetable for the transaction; and
assigning portions of the ownership interest at multiple time intervals based on the timetable, wherein all of the ownership interest is assigned when the timetable is completed.

4. The method of claim 3, further comprising:
at each of the multiple time intervals:
retrieving at least one of an updated profitability factor, an updated value factor, and an updated list of outstanding ownership interests; and
recalculating a respective portion of the ownership interest based on the at least one of the updated profitability factor, the updated value factor, and the updated list of outstanding ownership interests.

5. The method of claim 7, wherein the ownership interest is one of a non-voting share of the business or a voting share of the business.

6. The method of claim 7, wherein the ownership interest vests over a period of time associated with the transaction.

7. The method of claim 7, further comprising:
calculating an actual profitability for the transaction; and
revising the ownership interest in the business based on the actual profitability.

8. The method of claim 7, further comprising:
assigning a status indicator to the customer, wherein the status indicator is associated with the transaction.

9. The method of claim 7, wherein assigning the ownership interest comprises at least one of transferring the ownership interest to one of an individual, a business entity, a retirement account, a non-profit organization, or a trust.

10. The method of claim 7, wherein the value factor is provided by a third-party appraisal.

11. The method of claim 7, wherein the ownership interest is assigned with at least one restriction.

12. The method of claim 7, wherein at least one of calculating the profitability factor, retrieving the value factor, retrieving the list of outstanding ownership interests, and assigning the ownership interest occurs after initiation of the transaction.

13. The method of claim 7, further comprising:
assigning, in association with the transaction, a second ownership interest in the business to an entity that referred the customer to the business.

14. The method of claim 7, wherein the ownership interest is further based on a current profitability of the business.

15. The method of claim 7, wherein the profitability factor reflects an expected amount of profit to the business from the transaction.

16. The method of claim 7, wherein the transaction comprises at least one of a mortgage or a sale of a good or service.

17. The method of claim 7, wherein the ownership interest is assigned as directed by the customer.

18. A system comprising:
a processor; and
a storage device having stored therein instructions which, when executed by the processor, cause the processor to perform operations comprising:
calculating a profitability factor for a transaction between a business and a customer;
retrieving a value factor representing a value of the business;
retrieving a list of outstanding ownership interests in the business; and
assigning, in association with the transaction, an ownership interest in the business, wherein the ownership interest is based on at least one of the profitability factor, the value factor, and the list of outstanding ownership interests in the business.

19. The system of claim 18, the instructions, when executed by the processor, causing the processor to perform operations further comprising:
determining a timetable for the transaction;
assigning portions of the ownership interest at multiple time intervals based on the timetable, wherein all of the ownership interest is assigned when the timetable is completed; and
at each of the multiple time intervals, retrieving at least one of an updated profitability factor, an updated value factor, and an updated list of outstanding ownership interests, and recalculating a respective portion of the ownership interest based on the at least one of the updated profitability factor, the updated value factor, and the updated list of outstanding ownership interests.

20. A non-transitory computer-readable storage medium storing instructions which, when executed by a computing device, cause the computing device to perform operations comprising:
calculating a profitability factor for a transaction between a business and a customer;
retrieving a value factor representing a value of the business;
retrieving a list of outstanding ownership interests in the business; and
assigning, in association with the transaction, an ownership interest in the business, wherein the ownership interest is based on at least one of the profitability factor, the value factor, and the list of outstanding ownership interests in the business.
